(19) United States
(12) Patent Application Publication
(10) Pub. No.: US 2003/0075830 A1
(43) Pub. Date: Apr. 24, 2003

(54) Method and apparatus for producing a form body of cooked sugar mass in a mold

(76) Inventor: Thomas Sollich, Kalletal (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/273,633

(22) Filed: Oct. 18, 2002

(30) Foreign Application Priority Data
Oct. 23, 2001 (DE) 10152289.4-41

(51) Int. Cl. B29C 43/04

(52) U.S. Cl. 264/313; 264/319

(57) ABSTRACT

A method of producing an edible product of the sweets industry includes the steps of filling a liquid sugar mass into a mold to only partly fill the mold, the mold at least partly being made of an elastic and resilient material and including a wall, displacing the liquid sugar mass along the wall of the mold by a stamp element, and solidifying the sugar mass between the stamp element and the wall of the mold to attain a solid hollow body. The solid hollow body may then be filled with at least one additional mass to attain an edible product of the sweets industry. Finally, the product is ejected from the mold by at least partly reversing the elastic mold. The apparatus for producing the product includes at least one mold at least partly being made of an elastic and resilient material, at least one stamp element to temporarily dislocate sugar mass contained in the mold, and at least one supporting mold to support the mold from below at least when the stamp element dislocates the sugar mass contained in the mold.

### CROSS REFERENCE TO RELATED APPLICATIONS

This application claims priority to co-pending German Patent Application No. 101 52 289.4 entitled “Verfahren und Vorrichtung zum Herstellen eines Formkörpers aus gekochter Zuckermasse in einer Form”, filed Oct. 23, 2001.

### FIELD OF THE INVENTION

The present invention generally relates to a method and an apparatus for producing an edible form body of cooked sugar mass in a mold. The fluidized or liquid sugar mass is poured into the mold, the mold at least partly being made of an elastic material. The sugar mass is solidified in the mold. The solid form body resulting therefrom is ejected from the mold. The term “cooked sugar mass” used in this application is to be understood in a broad sense. It is to be understood as to include all sugar masses of the sweets industry and the candy industry which at least include a substantial portion of sugar. Such sugar masses usually are hard, or they have medium hardness at room temperature. The sugar mass is cooked, and it reaches a liquid, pourable condition under the effect of heat.

The sugar is solved in water, and it is then intermixed with the other components of the mass. Due to the following cooking of the sugar mass, the sugar solution is dehumidified to a great extent. The remaining mass in its hard condition is still flowable and deformable. When cooling down, the sugar mass again solidifies, and it reaches a solid shape. For example, such cooked sugar masses may be candy masses for hard candy or soft candy, caramel masses, fondant masses, fruit masses, jelly masses and nougat masses. It is desired to produce shell-like form bodies from such a cooked sugar mass. The attained solid shell mostly is a partial product. Usually, it is then filled with one or more additional masses, it may be covered, or it may be further processed in a different way to produce an edible product of the sweets industry.

### BACKGROUND OF THE INVENTION

A method and an apparatus for producing a form body of cooked sugar mass in a mold is known from German Patent No. 872 149. A mold being made of rubber is used to produce massive or solid form bodies of hardenable, ductile masses, especially cooked sugar masses. The mold includes a stiff outer rim, a stiff bottom portion and an elastic wall portion connecting its two stiff portions. Consequently, the mold is at least partly made of rubber. For producing massive form bodies, the mold is filled with liquid sugar mass. The sugar mass solidifies in the mold due to natural cooling-down effects. The mold with the solid form body is then turned around, and the form body is ejected from the mold. The elastic properties of the mold are used for ejection of the form body. The stiff portions of the mold serve to prevent the form body to be ejected from being damaged.

An apparatus with which shell-like form bodies of masses containing fat—especially chocolate masses—may be produced is known from British Patent No. 207,974. The liquid fat-containing containing mass is filled into the mold being opened in an upward direction. The mold is made of a stiff, undeformable material, especially metal. The mold is partly filled with such an amount of the mass as it is required for producing the shell. A stamp element is moved in a downward direction to contact the liquid mass from above such that the mass fills the intermediate space between the stamp element and such that the mass reaches the rim of the mold. The stamp element is connected to a cooling circuit to cool the chocolate mass, and to solidify the chocolate mass. It is a drawback that the liquid mass directly contacts the stamp element until the shell has hardened. To be capable of removing the stamp element from the shell, the stamp element is covered with a lubricant which may be a fluid or another solution. Alcohol, terpene, edible paraffines, water and gelatine are mentioned as such separating agents. These separating agents are used in the region of the stamp element. The mold is not being cooled, and it is obviously not treated with a separating agent. It is not possible to produce shell-like form bodies of masses containing sugar. Such sugar masses would stick to the stiff mold and to the stamp element, meaning they could not be reproducibly removed from the mold. There would be the danger of shell-like form bodies—especially such ones having thin walls—being damaged during removal and/or ejection.

A method of producing shell-like hollow bodies of chocolate or of another mass containing fat is known from European Patent Application No. 0 589 820 A1 corresponding to U.S. Pat. No. 5,705,217. The fat-containing mass in its fluidized condition is poured into a stiff mold. Preferably, the mold is made of hard polycarbonate. A stamp element being movable up and down and being connected to a cooling circuit is lowered into the liquid mass contained in the mold. The stamp has a temperature of is less than 0° C. (32° F.), and it remains in the mass dislocated thereby for a certain period of time, usually between 1 and 10 seconds. It is desired that the temperature of the mold is less than the temperature of the mass. It is known that chocolate masses and other fat-containing masses which contract during solidification may be removed from a mold in a comparatively easy way. This is achieved by turning the mold and by knocking out the product. With this known method, it is possible to produce shells having uniform wall thickness. It is desired that the shells may be easily removed from the stamp element when it is strongly cooled.

German Patent Application No. 197 32 036 A1 corresponding to U.S. Pat. No. 6,268,006 relates to the production of shell-like form bodies of fat-containing masses. As examples, an outer fat shell of dog food, a chocolate shell and the like are mentioned. The production of such consumable products with an outer shell is achieved by extruding by a tempered stamp element being immersed into the mold. When such stamp elements are cooled to reach a temperature of less than 0° C. (32° F.), there is a very thin layer of ice on the surface of the stamp element when operating at a temperature of less than the ambient temperature. The layer of ice acts as a separating agent between the stamp element and the chocolate mass. Due to this thin layer of ice, there may be undesired specking effects. To prevent specking, the dew point of the atmosphere surrounding the consumable product is kept below the temperature of the stamp element. By choosing special materials—for example copper and silver—for certain parts of the stamp element and/or the mold, one tries to have a positive influence on heat transport and on preventing specking.

All the above described methods and apparatuses known from the prior art (with the exception of the ones known from German Patent No. 872 149) relate to processing of fat-containing masses, especially chocolate masses. Compared to such fat-containing masses, cooked sugar masses have substantially more problematic properties. They tend to stick to the mold to a greater extent, and it is substantially more difficult to eject them from the mold.

All known methods and apparatuses relating to processing of cooked sugar masses serve to produce massive form bodies, meaning solid products not including openings and not being designed as hollow shells. There is no known technically useful method for producing shell-like form bodies of cooked sugar mass.

For example, the leaflet “CANDYMASTER” (printed February 1999) of the Applicant shows powderless casting facilities for hard sugar products in which stiff molds of aluminum diecast being coated with polytetraflour ethylene are used. After having solidified, the massive form bodies are pressed out off the mold by pushing elements protruding through the body of the mold. To cast products from low-cooked sugar masses without powder, such as fondant, caramel, toffee, fudge and the like, it is already known to use flexible molds being made of silicone rubber. These molds have a substantial wall thickness, but they may be deformed by an ejector. In this way, massive form bodies may be produced, even such ones in which two or more masses are filled into the mold. The fill factor—meaning the volumetric proportion of the inner enclosed mass—is limited. The outer mass forms some sort of a shell-like container, but this container has to have a substantial wall thickness. It is not possible to produce shell-like form bodies with thin walls and having defined inner surfaces.

### SUMMARY OF THE INVENTION

The present invention relates to a method of producing a form body of a cooked sugar mass in a mold. The method includes the steps of pouring the liquid sugar mass into the mold to only partly fill the mold as it is required for producing a shell-like form body, the mold at least partly being made of an elastic and resilient material and including a wall, dislocating the liquid sugar mass along the wall of the mold by a stamp element, solidifying the sugar mass between the stamp element and the wall of the mold to form a solid shell-like form body, and ejecting the solid form body from the mold by at least partly reversing the mold.

The present invention also relates to a method of producing an edible product. The method includes the steps of filling a liquid sugar mass into a mold to only partly fill the mold, the mold at least partly being made of an elastic and resilient material and including a wall, displacing the liquid sugar mass along the wall of the mold by a stamp element, solidifying the sugar mass between the stamp element and the wall of the mold to attain a solid hollow body, filling at least one additional mass into the solid hollow body to attain an edible product, and ejecting the product from the mold by at least partly reversing the mold.

The present invention also relates to an apparatus for producing a form body of a cooked sugar mass. The apparatus includes at least one mold at least partly being made of an elastic and resilient material and being designed and arranged to be at least partly filled with fluid sugar mass from above, at least one stamp element being associated with the mold and being designed and arranged to be moved into the mold from above in a stroke-like way to temporarily dislocate sugar mass contained in the mold, and at least one supporting mold being designed and arranged to support the mold from below at least when the stamp element dislocates the sugar mass contained in the mold.

The present invention also relates to an apparatus for producing an edible product of the sweets industry including a shell being made of a cooked sugar mass. The apparatus includes a plurality of molds each including a wall and at least partly being made of an elastic and resilient material, each of the molds being designed and arranged to be at least partly filled with fluid sugar mass, a plurality of stamp elements each being associated with at least one of the molds and being designed and arranged to be moved into the mold to displace liquid sugar mass contained in the mold along the wall of the mold, the liquid sugar mass in its dislocated position between the stamp element and the wall of the mold solidifying to form a hollow body, and a plurality of supporting molds each being associated with at least one of the molds and being designed and arranged to support the mold from below at least when the stamp element dislocates the sugar mass contained in the mold.

With the novel method and apparatus, it is possible to produce shell-like hollow bodies of cooked sugar mass without the problem of the sugar mass and the shell, respectively, sticking to the stamp element. Consequently, the shell or the finished product may be removed from the mold even when being made of sugar masses which are difficult to be handled.

With the novel method and apparatus, it is possible to produce shell-like bodies of cooked sugar mass by extruding and by using elastic molds. The boundary between fat-containing chocolate masses and cooked sugar masses is overcome with the present invention. It is known that chocolate masses contract during cooling down and solidifying. This effect is used to separate the solid form bodies from the mold and to eject the form body. It is also known that sugar masses do not have such properties. Consequently, one with skill in the art would not orient oneself toward the production of shell-like hollow bodies of chocolate mass substantially containing fat when having to produce shell-like form bodies of cooked sugar mass substantially containing sugar. However, the present invention has chosen this way for the first time, and it uses elastic molds in a duplicate way, namely for simplified separating of the sensitive shell-like form body from the mold and the stamp element, on the one hand, and for ejecting the shell-like form body, on the other hand. Both steps are realized more or less at the same time and in close time-wise coordination. Due to the use of a membrane-like mold having thin walls, it is possible to produce a sensitive, shell-like form body in the mold, and to eject it without any damages occurring.

It makes sense to at least partly fill the shell-like form body with an additional mass before separating and ejecting it from the mold. In this way, the sensitive, shell-like form body is stiffened from the inside. The utilized molds of an elastic material may, for example, be made of silicone, and they may at least be partly made of thin walls such that they are reversed when ejecting the shell-like form body from the mold. This reversing process may be finished as soon as the shell-like form body has been detached from the mold. The elastic material of the molds also has respective resilient properties, meaning the molds automatically regain their initial shape after having finished the partial reversing movement.

The membrane-like mold being made of an elastic and resilient material at least during the step of dislocating the sugar mass with the stamp element may be supported by a supporting mold. The supporting mold at least partly has the shape of the mold, and it supports the elastic material of the mold especially during insertion of the stamp element into the mass. In this way, it is possible to produce shells being uniform to a great extent such that their walls have a uniform thickness. During the shaping process of the fluid sugar mass in the mold by the stamp element, there is good contact between the elastic sugar mass and the mold and the stamp element such that there is a respective transfer of heat as it is required for the process of the cooked sugar mass solidifying.

It makes sense if the supporting mold is removed before ejecting the shell-like form body. The mold, on the one hand, and the supporting mold, on the other hand, are moved apart before ejecting the form body such that, for example, a pushing element may engage the elastic mold. The shell-like form body is detached from the mold and ejected from the mold more or less at the same time.

The stamp element and/or the mold and/or the supporting mold may be cooled. For this purpose, these elements may be connected to one or more cooling circuits. Tempering of the cooling circuits is coordinated with the kind and the properties of the respective sugar masses.

The shell-like form body may be filled with one or more additional masses, it may be covered, or it may be processed in a different way to produce an edible product of the sweets and candy industry. Especially, such a shell-like form body being stiffened in the inside may be fed to a coating apparatus, and it may be coated with a chocolate mass. However, the unfilled shell-like form body is also suitable as an edible product.

The stamp element may be rotatably driven at least when the sugar mass is dislocated in the mold. The stamp element is driven at a comparatively low number of revolutions, and there may additionally be a vibrational operation.

With the novel apparatus including a mold being made of an elastic material, it is possible to produce shells of cooked sugar mass having comparatively thin walls. Especially highly cooked hard sugar mass is very brittle and sensitive to pressure. It is surprising that it is now possible to produce shell-like form bodies of such a highly cooked hard sugar mass having a comparatively thin wall thickness. The production of hollow bodies of low cooked soft sugar mass having thin walls is less problematic. Such soft sugar masses are caramel, toffee, fudge, fondant, fruit jellies or nougat.

The use of an elastic, resilient material for the mold has a plurality of advantages. Especially silicone used in a thin shape simplifies removal of the form body from the mold and ejecting the body from the mold.

In the case of processing cooked sugar masses being sticky to a great extent and being difficult to be processed, the stamp element and/or the membrane-like mold may be coated with a coating serving to simplify removal of the solid shell-like form body. For example, such a coating may be polytetrafluor ethylene or a similar plastic material.

The stamp element and/or the membrane-like mold and/or the supporting mold may be connected to a cooling circuit to improve heat transfer and to attain short clock times. It is also possible to use a plurality of cooling circuits. The cooling circuits may be operated at different temperatures to cool to different extents. It has to be taken into account that the solidification process occurring inside of the shell-like form body and being caused by the cooling effect is initiated not before the sugar mass has been dislocated to reach the gap between the stamp element and the mold.

When the stamp element, the mold and the supporting mold are designed and coordinated with one another such that the shell-like form body has a wall thickness of approximately 2 mm, it is possible to produce form bodies of difficult cooked sugar masses, the form bodies being practically useful and easy to be handled. Such shell-like form bodies may then be filled with one or more additional masses. Advantageously, a substantially greater fill factor is reached than it is the case when pouring two sugar masses into one mold at the same time when producing massive form bodies as it is know in the prior art.

In a preferred exemplary embodiment, the mold at least includes an elastically deformable portion having thin walls. The supporting mold may be designed to be annular. Despite of the annular shape, there is sufficient support of the elastic mold during the process of dislocating the sugar mass by the stamp element. The opening being located in the annular supporting mold may be used to arrange an ejector element, the ejector element being driven to fulfill a stroke-like movement to reverse the elastic mold.

Other features and advantages of the present invention will become apparent to one with skill in the art upon examination of the following drawings and the detailed description. It is intended that all such additional features and advantages be included herein within the scope of the present invention, as defined by the claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a schematic side view of the novel apparatus for producing a form body of a cooked sugar mass in a mold at least partly being made of an elastic material.

FIG. 2 is a schematic view of a cross section of one single mold during introduction of the liquid sugar mass.

FIG. 3 is a view of the mold according to FIG. 2 after distribution of the sugar mass.

FIG. 4 is a view of the relative position of the elements of the novel apparatus after partly lowering the stamp element.

FIG. 5 is a view of another intermediate position of the novel apparatus.

FIG. 6 is a view of a position of the elements of the novel apparatus during the process of dislocating and hardening of the sugar mass.

FIG. 7 is a view of the sugar mass still being located in the mold and having hardened to form a shell-like form body.

FIG. 8 is a similar view as FIG. 6 but illustrating another exemplary embodiment of the stamp element.

FIG. 9 is a view of another exemplary embodiment of the mold.

FIG. 10 is a view of another exemplary embodiment of the mold.

FIG. 11 is a top view of the mold having a first shape.

FIG. 12 is a top view of the mold having a second shape.

FIG. 13 is a top view of the mold having a third shape.

FIG. 14 is a schematic view of the elements of the novel apparatus before introduction of a mass into the solidified shell-like form body.

FIG. 15 is a schematic view of the elements of the novel apparatus during introduction of the mass into the solidified shell-like form body.

FIG. 16 is a view of the mold and the shell-like form body and the additionally introduced mass.

FIG. 17 is a cross-sectional view of the mold after the turning around movement.

FIG. 18 is a cross-sectional view of the elements of the novel apparatus just during the process of reversing the mold and during ejection of the product from the mold.

FIG. 19 is a schematic view of the elements of the novel apparatus after ejection of the product.

FIG. 20 is a schematic vertical sectional view of the novel apparatus including a rotatably driven stamp element.

### DETAILED DESCRIPTION

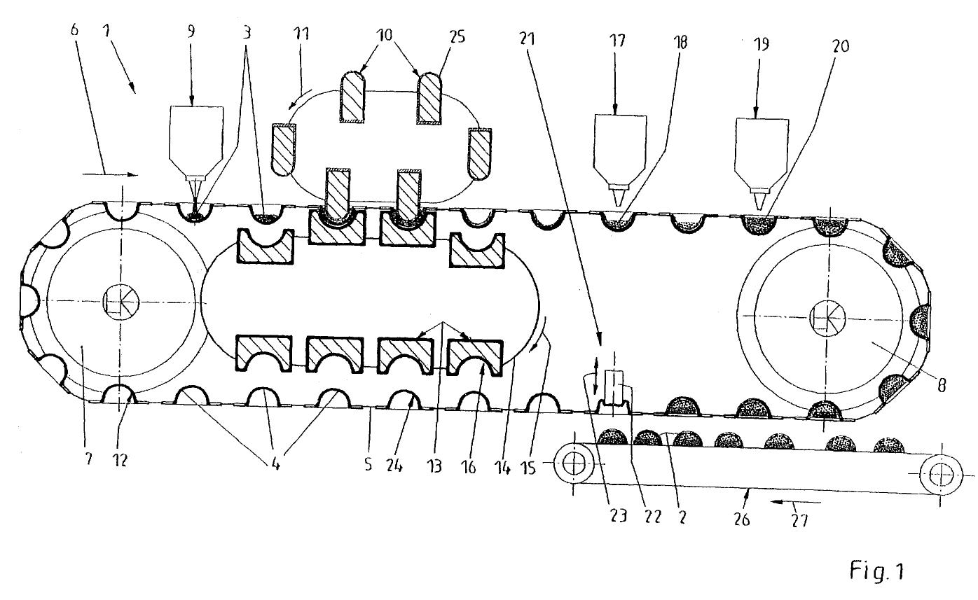

Referring now in greater detail to the drawings, FIG. 1 illustrates a novel apparatus 1 for producing shell-like form bodies 2 or mold bodies of cooked sugar mass 3. There is a majority of molds 4, the molds 4 having a cup-like or bowl-like shape. FIG. 1 only shows a cross-sectional view of these molds 4. The molds 4 are arranged on a continuous conveyor belt 5 being rotatably driven about two deflection wheels 7 and 8 according to arrow 6. The drive may be continuous or clocked.

In the region of the upper part, there is a cast station 9 for pouring a portion of cooked sugar mass 3 into the mold 4. It is to be seen that the mold 4 is only partly filled with sugar mass 3. The respective amount of the introduced portion is coordinated with the design of the shell-like body, especially with its wall thickness. Downstream of the cast station 9, there may be a vibrational or shaking station (not illustrated) to make sure that the introduced portion of the sugar mass 3 is distributed in the mold 4 in a uniform way to reach a horizontal level.

Stamp elements 10 are located above the molds 4, the stamp elements 10 being rotatably driven according to arrow 11. The drive for the stamp elements 10 is coordinated with the drive for the molds 4, and it may be continuous or clocked. The stamp elements 10 are arranged and moved in a way such that they enter the molds 4 from the open side and such that they dislocate the introduced portion of cooked sugar mass 3 at the wall 12 in an upward direction. The associated surfaces of the mold 4 and of the stamp element 10 are coordinated with respect to one another to attain approximately uniform wall thickness of the shell-like form body 2. Each stamp element 10 remains in the mold 4 for a certain period of time until the liquid or pasty sugar mass has solidified to form the solid body 2. In the following, the respective stamp element 10 is moved out off the mold 4 and the form body 2, respectively, in an upward direction.

A number of supporting molds 13 are associated with the molds 4 and the stamp elements 10. The supporting molds 13 are also located on a continuous transportation unit 14, and they are rotatably driven according to arrow 15. The supporting molds 13 are arranged below the molds 4. They include impressions 16 the shape of which is coordinated with the shape of the molds 4 and of the stamp elements 10. The supporting molds 13 serve to support the molds 4 during operation of the stamp elements 10 and during dislocation of the sugar mass 3. The molds 4 are at least partly made of an elastic resilient material, as for example, rubber, silicone and the like. The molds 4 may be completely or partly made of this material. They have comparatively thin walls to make it possible to push them through during ejection of the shell-like form bodies 2, and to simplify removal of the form bodies 2.

Further downstream of the path of transportation, there is another cast station 17 serving to introduce a second mass 18 to be contained in the shell-like form body 2. There may also be a third cast station 19 with which another mass 20, for example a cover mass, may be introduced. The number of cast stations 17 and 19 may be freely chosen. However, it is also possible to only produce shell-like hollow bodies 2 which are the edible product. The masses 18 and 20 solidify during the conveying movement of the molds 4 according to arrow 6. It is to be understood that it is also possible to arrange a cooling tunnel and the like at this place to solidify masses which are difficult to be handled and which have to be introduced at comparatively high temperatures.

The molds 4 are turned around in the region of the deflection wheel 8. At this place, there is a removing station 21 including an ejector element 22, the ejector element 22 being driven to fulfill a stroke according to arrow 23. The ejector element 22 reverses the respective mold 4. Consequently, the shell-like form body 2 and the finished product, respectively, is removed from the mold 4. For simplified removal, the molds 4 may include a coating 24, or they may be treated with a separating agent. The same applies to the stamp elements 10. The contacting surface of the stamp elements 10 may include a coating 25.

The shell-like form bodies 2 with the optionally introduced masses 18 and 20 as solid products are placed upon a removal conveyor belt 26 with which they are transported to a cooling tunnel and a packing machine located downstream thereof, for example. The removing conveyor belt 26 is rotatably driven in the direction of arrow 27.

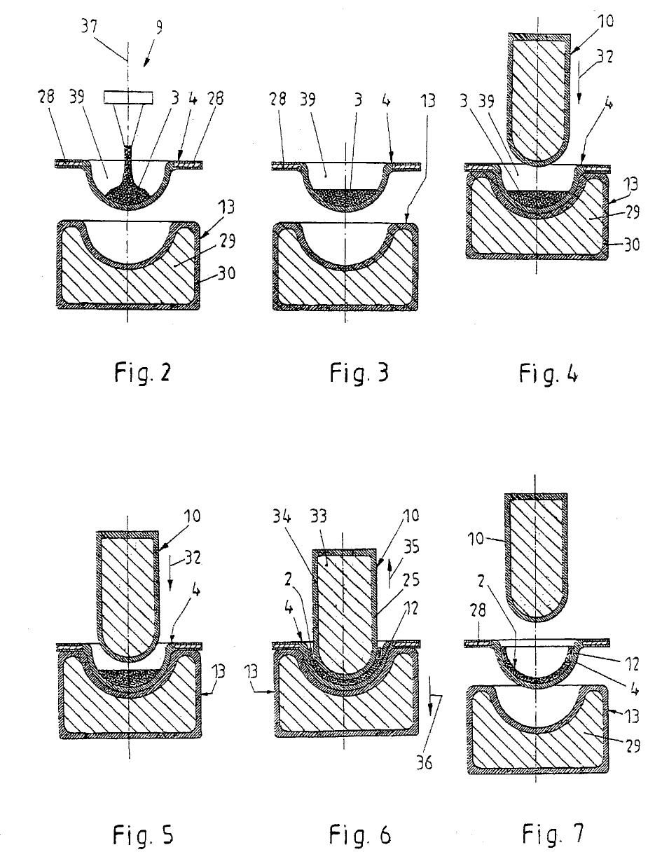

FIGS. 2 to 7 illustrate the process of shaping the shell-like form bodies 2 in even greater detail.

FIG. 2 illustrates the position of the elements of the novel apparatus during introduction of a respective portion of cooked sugar mass 3 into the impression of a mold 4. It is to be seen that the mold 4 is designed to have thin walls similar to a membrane. In the illustrated embodiment, it is made of silicone, and it only in the rim portion protruding over the impression includes strengthening elements 28 made of metal. The strengthening elements 28 serve to support and connect the molds 4 with the transportation conveyor belt 5. The associated supporting mold 13 is still located at a distance with respect to the mold 4, but may also already support the mold 4 when the sugar mass 3 is poured into the mold 4. Each supporting mold 13 includes a core 29 being made of plastic and a casing being made of metal. The mold 4 may also have a different structure, as this will be explained in the following.

FIG. 3 illustrates the relative position of the elements of the novel apparatus after the portion of introduced cooked sugar mass 3 has uniformly distributed in the mold 4. The support mold 13 is then moved in an upward direction according to arrow 31 in a stroke-like way such that it supports the bottom side of the mold 4 in case it has not already supported the mold 4 before introduction of the sugar mass 3.

The stroke-like movement of the supporting mold 13 in an upward direction has been completed in FIG. 4. FIG. 4 illustrates a stamp element 10 which is lowered from above through the opening of the mold 4 in a downward direction according to arrow 31.

FIG. 5 illustrates an intermediate position of the elements of the novel apparatus during continued movement of the stamp element 10 according to arrow 32.

FIG. 6 illustrates the end position of the stamp element 10 in the mold 4. The movement of the stamp element 10 with respect to the mold 4 is controlled to end in a way that the introduced portion of cooked sugar mass 3 is dislocated in the mold 4. Contacting the wall 12 of the mold 4, the sugar mass 3 raises in the mold 4 to finally solidify to form the shell-like body 2. The stamp element 10 may also be made of a core 33 being made of plastic and a casing 34 being made of metal.

After solidification of the sugar mass 3 to form the shell-like body 2, the stamp element 10 is lifted according to arrow 35, the stamp element 10 then getting detached from the body 2. For this purpose, the coating 25 may be helpful. The supporting mold 13 is then moved in a downward direction according to arrow 36, meaning it is detached from the bottom side of the mold 4. This movement may occur more or less at the same time or at a different time compared to the movement of the stamp element 10.

The end position of this movement and the relative position resulting therefrom are illustrated in FIG. 7. Detaching and ejecting, respectively, of the body 2 from the mold 4 may be achieved in a way as it has already been described with reference to FIG. 1.

The molds 4 and the associated shape of the stamp elements 10 and of the supporting molds 13 primarily is rotationally symmetrical with respect to a center axis 37 (FIG. 2). Consequently, round, cup-like or bowl-like bodies 2 may be produced. However, the products may also have the shape of a praline, a cherry and the like. For attaining an exact shape of the rim of the body 2, it usually is sufficient to make sure that the portion of sugar mass 3 which has been introduced into the mold 4 is uniformly distributed according to FIG. 3.

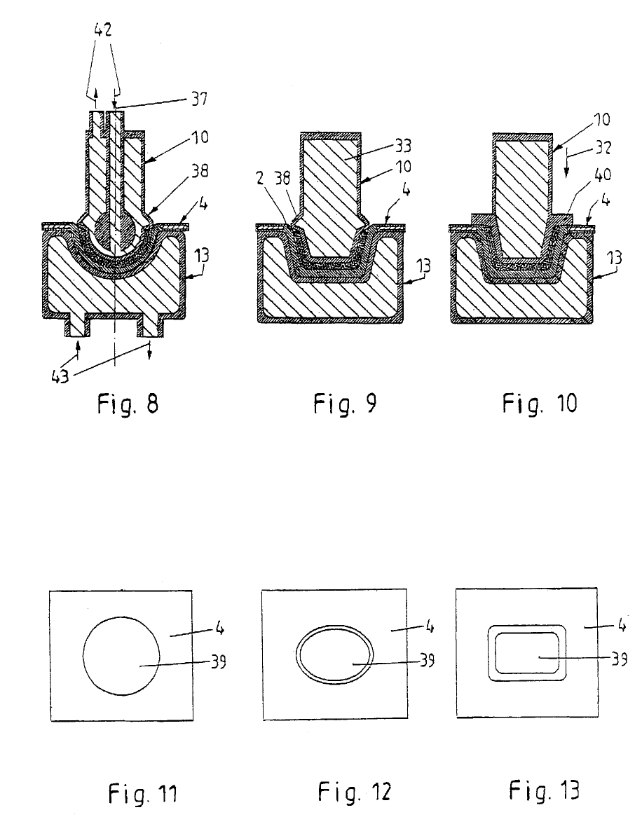

As illustrated in FIGS. 8-10, there additionally is the possibility of the stamp elements 10 having a special rim portion 38 protruding in an outward direction to be coordinated with the wall thickness of the form bodies 2 and the shape of the mold 4. FIG. 8 illustrates such a design.

FIG. 11 illustrates a top view of the empty mold 4 according to FIG. 8 including an impression 39 serving to produce such an approximately semicircular form body 2. However, the present invention may not only be used to produce such rotationally symmetrical form bodies 2.

FIGS. 9 and 12 illustrate the design of the mold 4 for producing elliptically-conical products.

FIGS. 10 and 13 illustrate molds 4 having sort of a rectangular design with rounded edge portions. In this case, the stamp element 10 may include a rim 40 protruding in an outward direction. The rim 40 in the end position contacts the upper side of the mold 4 such that the rim of the form body 2 is mold.

It may also be seen from FIG. 8 that the stamp element 10 may be connected to a cooling circuit 42. A control unit (not illustrated) is located in the cooling circuit 42 such that a cooling medium being controlled with respect to its temperature and its amount flows through the stamp element 10. Usually, the stamp element 10 is made of metal. In a similar way, there is a cooling circuit 43 being associated with the supporting mold 13. The cooling circuits 42 and 43 may be separate, or they may be combined to form one common cooling circuit.

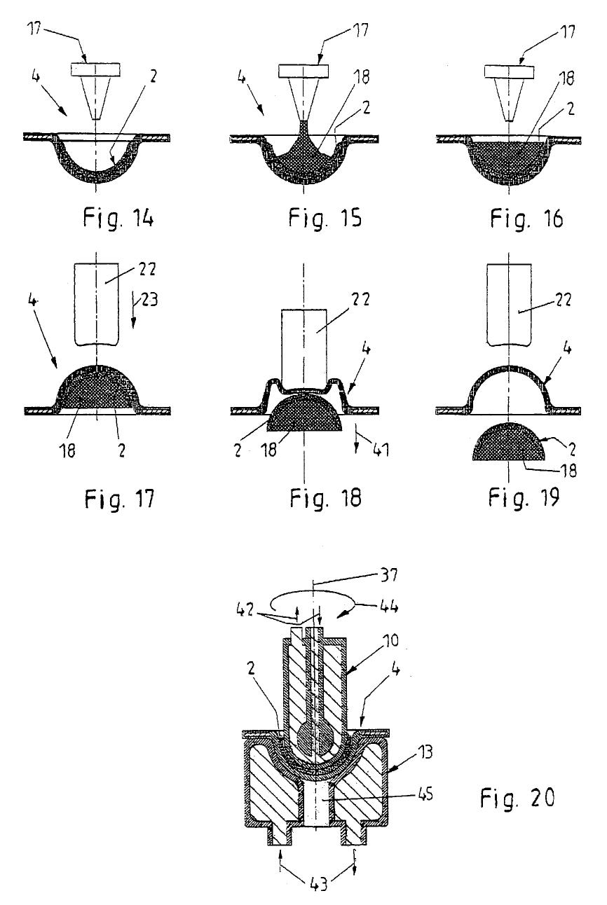

FIGS. 14-19 illustrate how a second mass 18 is poured into an already existing shell-like form body 2 and how the finished product is ejected.

According to FIGS. 14 and 15, the mass 18 is poured into the hardened, shell-like form body 2. The mass 18 is uniformly distributed according to FIG. 16, and it solidifies to form the shell 2 in the mold 4.

FIG. 17 illustrates the turning around movement of the mold 4 and the downward movement of the ejector element 22 according to arrow 23.

According to FIG. 18, the mold 4 is partly reversed by the ejector element 22. Thus, the shell-like form body 2 and the solidified product, respectively, being located in the mold 4 is released, and it is ejected in a downward direction according to arrow 41 such that it reaches the conveyor belt 26 (FIG. 1), for example. The ejector element 22 is then further lifted as illustrated in FIG. 19, and it reaches its initial position and its inoperative position, respectively.

FIG. 20 illustrates another exemplary embodiment of the elements for shaping including the two cooling circuits 42 and 43. In this case, the stamp element 10 is additionally driven to rotate about the longitudinal axis 37. The drive is realized at comparatively low numbers of rotation according to arrow 44, and it is at least active during the act of dislocating the introduced sugar mass 3. In this case, the supporting mold 13 has an annular design, meaning it includes an opening 45 being located in the bottom portion, the opening 45 after turning of the mold 4 being capable of being used for passage of the ejector element 22. This does not necessarily mean that the supporting mold 13 has a rotationally symmetrical design. The supporting mold 13 may contact the mold 4 for an increased period of time to supply for a more intense cooling effect.

Many variations and modifications may be made to the preferred embodiments of the invention without departing substantially from the spirit and principles of the invention. All such modifications and variations are intended to be included herein within the scope of the present invention, as defined by the following claims.

I claim:

1. A method of producing a form body of a cooked sugar mass in a mold, said method comprising the steps of:
pouring the liquid sugar mass into the mold to only partly fill the mold as is required for producing a shell-like form body, the mold at least partly being made of an elastic and resilient material and including a wall;
dislocating the liquid sugar mass along the wall of the mold by a stamp element;
solidifying the sugar mass between the stamp element and the wall of the mold to form a solid shell-like form body; and
ejecting the solid form body from the mold by at least partly reversing the mold.

2. The method of claim 1, further comprising the step of supporting the mold with a supporting mold at least during the step of dislocating the sugar mass.

3. The method of claim 2, further comprising the step of removing the supporting mold before the step of ejecting the solid form body.

4. The method of claim 1, further comprising the step of cooling the stamp element.

5. The method of claim 1, further comprising the step of cooling the mold.

6. The method of claim 1, further comprising the step of cooling the stamp element and the mold.

7. The method of claim 2, further comprising the step of cooling the supporting mold.

8. The method of claim 2, further comprising the step of cooling the stamp element, the mold and the supporting mold.

9. The method of claim 1, further comprising the step of filling the solid shell-like form body with at least one additional mass before ejecting the solid form body from the mold to attain an edible product.

10. The method of claim 1, further comprising the step of rotatably driving the stamp element at least during the step of dislocating the sugar mass.

11. A method of producing an edible product of the sweets industry, said method comprising the steps of:
filling a liquid sugar mass into a mold to only partly fill the mold, the mold at least partly being made of an elastic and resilient material and including a wall;
displacing the liquid sugar mass along the wall of the mold by a stamp element;
solidifying the sugar mass between the stamp element and the wall of the mold to attain a solid hollow body;
filling at least one additional mass into the solid hollow body to attain an edible product; and
ejecting the product from the mold by at least partly reversing the mold.

12. The method of claim 11, further comprising the step of supporting the mold with a supporting mold at least during the step of displacing the sugar mass.

13. The method of claim 11, further comprising the step of rotatably driving the stamp element at least during the step of displacing the sugar mass.

14. An apparatus for producing a form body of a cooked sugar mass, comprising:
at least one mold at least partly being made of an elastic and resilient material and being designed and arranged to be at least partly filled with fluid sugar mass from above;
at least one stamp element being associated with said mold and being designed and arranged to be moved into said mold from above in a stroke-like way to temporarily dislocate sugar mass contained in said mold; and
at least one supporting mold being designed and arranged to support said mold from below at least when said stamp element dislocates the sugar mass contained in said mold.

15. The apparatus of claim 14, wherein said stamp element includes a coating being designed and arranged to simplify detachment from the sugar mass having solidified as a shell-like form body.

16. The apparatus of claim 14, wherein said mold includes a coating being designed and arranged to simplify detachment from the sugar mass having solidified as a shell-like form body.

17. The apparatus of claim 14, wherein said stamp element and said mold each include a coating being designed and arranged to simplify detachment from the sugar mass having solidified as a shell-like form body.

18. The apparatus of claim 14, further comprising at least one cooling circuit, said stamp element being connected to said at least one cooling circuit.

19. The apparatus of claim 14, further comprising at least one cooling circuit, said mold being connected to said at least one cooling circuit.

20. The apparatus of claim 14, further comprising at least one cooling circuit, said stamp element and said mold being connected to said at least one cooling circuit.

21. The apparatus of claim 14, wherein said stamp element, said mold and said supporting mold are designed and arranged such that the sugar mass solidifies as a shell-like form body having a wall thickness of approximately 2 mm.

22. The apparatus of claim 14, wherein said mold includes at least a portion being elastically deformable and having thin walls, and wherein said supporting mold has an annular design.

23. An apparatus for producing an edible product of the sweets industry including a shell being made of a cooked sugar mass, comprising:
a plurality of molds each including a wall and at least partly being made of an elastic and resilient material, each of said molds being designed and arranged to be at least partly filled with fluid sugar mass;
a plurality of stamp element each being associated with at least one of said molds and being designed and arranged to be moved into said mold to displace liquid sugar mass contained in said mold along said wall of said mold, the liquid sugar mass in its dislocated position between said stamp element and said wall of said mold solidifying to form a hollow body; and
a plurality of supporting molds each being associated with at least one of said molds and being designed and arranged to support said mold from below at least when said stamp element dislocates the sugar mass contained in said mold.

24. The apparatus of claim 23, wherein said stamp element and said mold each include a coating being designed and arranged to simplify detachment from the sugar mass having solidified as a hollow shell.

25. The apparatus of claim 23, wherein said mold includes at least a portion being elastically deformable and having thin walls, and wherein said supporting mold has an annular design.
